(19) United States
(12) Patent Application Publication
(10) Pub. No.: US 2016/0127092 A1
(43) Pub. Date: May 5, 2016

(54) CONTENTION BASED UPLINK TRANSMISSION FOR COVERAGE ENHANCEMENT

(71) Applicant: Microsoft Corporation, Redmond, WA (US)

(72) Inventor: Zhi Zhang, Beijing (CN)

(21) Appl. No.: 14/571,967

(22) Filed: Dec. 16, 2014

(30) Foreign Application Priority Data
Nov. 5, 2014 (CN) PCT/CN2014/090375

(51) Int. Cl. H04L 5/00; H04W 28/02; H04W 74/08; H04W 72/04; H04J 13/00

(52) U.S. Cl. CPC H04L 5/0048; H04W 72/0413; H04J 13/0062; H04W 74/0825; H04W 28/0278; H04L 5/0055

(57) ABSTRACT

This disclosure generally relates to contention based uplink transmission for coverage enhancement. A plurality of sequence patterns can be defined by a plurality of sequences and the order thereof. Each sequence pattern is uniquely associated with a UE. The UE may initiate the contention based uplink transmission with the associated sequence pattern. The BS may determine the number of UEs simultaneously transmitting on the shared resource by detecting the sequence patterns in the transmission. In this way, the BS can easily detect and handle collisions in the contention based transmission. The latency in uplink data transmission can be reduced with good system capacity.

### RELATED APPLICATIONS

This application claims priority to International Application No. PCT/CN2014/090375, filed on Nov. 5, 2014, and entitled “CONTENTION BASED UPLINK TRANSMISSION FOR COVERAGE ENHANCEMENT.” This application claims the benefit of the above-identified application, and the disclosure of the above-identified application is hereby incorporated by reference in its entirety as if set forth herein in full.

### BACKGROUND

Major effort has been put in recent years on the development of Third Generation Partnership Project (3GPP) Long Term Evolution (LTE), which provides Evolved Universal Mobile Telecommunications System (UMTS) terrestrial radio access (EUTRA) and EUTRA network (EUTRAN) technology for higher data rates and system capacity.

In general, the 3GPP systems can simultaneously support communication for multiple user equipment (UEs). Each UE communicates with one or more base stations (BSs) or other entities on the forward and/or reverse links. The forward link (or downlink) refers to the communication link from the BS to the UEs, and the reverse link (or uplink) refers to the communication link from the UEs to the BSs.

Some examples of UEs may be considered as machine type communication (MTC) devices, which may include remote devices such as sensors, meters, location tags, and the like. A MTC device may communicate with a BS, another remote device, or some other entities. Generally speaking, the transmission power of the MTC devices is relatively low. As a result, the coverage of such devices is limited as compared with other types of LTE UEs. At present, the enhancement of coverage is usually achieved by repetition of transmission. That is, the UE may transmit uplink data multiple times using the resources allocated by the BS.

### SUMMARY

Conventionally, when a UE has uplink data to transmit, the UE should first request uplink resources for data transmission. This procedure involves multiple rounds of commutations between the UE and BS. For a MTC device, due to the repetition of data transmission, such conventional request-based transmission mechanism will introduce significant latency. Contention based transmission has been proposed. However, in known contention based solutions, the UE has to monitor contention based grant from the BS, for example, on physical downlink control channel (PDCCH), which increases the decoding efforts of the UE. Moreover, the BS has no ability to control or even know the collisions among multiple UEs that simultaneously perform contention based transmission.

In accordance with embodiments of the subject matter described herein, the coverage enhancement is achieved by contention transmission based on sequence patterns. Given a collection of sequences, a plurality of patterns can be generated, for example, at the BS. Each pattern is defined by a certain order of the sequences and is uniquely associated with a UE. In operation, the UE may initiate the contention based uplink transmission on the shared resource. Along with the status information and possibly data, the UE transmits the sequences according the order defined by the associated pattern. The UE does not need to monitor PDCCH grant or send scheduling request.

The BS can easily detect collisions in the contention based transmission. More specifically, the BS may determine the number of UEs simultaneously transmitting on the shared resource by detecting the sequence patterns in the transmission. Moreover, the BS can recognize these UEs based on the sequence pattern. If there are two or more UEs transmitting uplink data, the BS may schedule retransmission of those UEs. In this way, it is possible to reduce latency in uplink data transmission while providing the BS with capability of recognizing and scheduling the colliding UEs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 illustrates a block diagram of user equipment in accordance with one embodiment of the subject matter described herein;

FIG. 2 illustrates a block diagram of an environment in which embodiments of the subject matter described herein may be implemented;

FIG. 3 illustrates a flowchart of a method for contention based uplink transmission at the UE side in accordance with one embodiment of the subject matter described herein;

FIG. 4 illustrates a schematic diagram of shared resource for contention based uplink transmission in accordance with one embodiment of the subject matter described herein;

FIG. 5 illustrates a flowchart of a method for controlling contention based uplink transmission at the BS side in accordance with one embodiment of the subject matter described herein;

FIG. 6 illustrates a block diagram of an apparatus for contention based uplink transmission at the UE side in accordance with one embodiment of the subject matter described herein; and

FIG. 7 illustrates a block diagram of an apparatus for contention based uplink transmission at the BS side in accordance with one embodiment of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “base station” (BS) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) refers to any device that is capable of communicating with the BS. By way of example, the UE may include a terminal, a Mobile Terminal (MT), a Subscriber Station (SS), a Portable Subscriber Station (PSS), a Mobile Station (MS), or an Access Terminal (AT). Specifically, some examples of UEs include MTC devices including, but not limited to, sensors, meters, location tags, and the like. It is to be understood that embodiments of the subject matter as described herein are applicable not only to MTC devices but also to any other types of non-MTC UEs.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

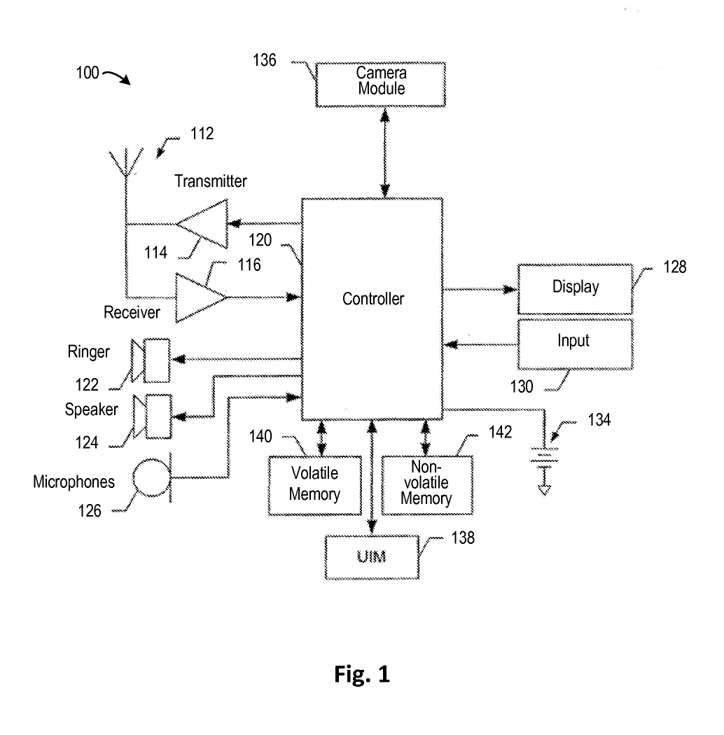

FIG. 1 illustrates a block diagram of a UE 100 in accordance with one embodiment of the subject matter described herein. In one embodiment, the UE 100 may be a MTC device with a wireless communication capability. However, it is to be understood that any other types of user devices may also easily adopt embodiments of the subject matter described herein, such as a mobile phone, a portable digital assistant (PDA), a pager, a mobile computer, a mobile TV, a game apparatus, a laptop, a tablet computer, a camera, a video camera, a GPS device, and other types of voice and textual communication system. A fixed-type device may likewise easily use embodiments of the subject matter described herein.

As shown, the UE 100 comprises one or more antennas 112 operable to communicate with the transmitter 114 and the receiver 116. With these devices, the UE 100 may perform cellular communications with one or more BSs. Specifically, the UE 100 may be configured to enhance its coverage by repeating the data transmission. That is, according to the grant and the resources allocated by the BS, the UE 100 may transmit the same uplink data multiple times.

The UE 100 further comprises at least one controller 120. It should be understood that the controller 120 comprises circuits or logic required to implement the functions of the user terminal 100. For example, the controller 120 may comprise a digital signal processor, a microprocessor, an A/D converter, a D/A converter, and/or any other suitable circuits. The control and signal processing functions of the UE 100 are allocated in accordance with respective capabilities of these devices.

Optionally, the UE 100 may further comprise a user interface, which, for example, may comprise a ringer 122, a speaker 124, a microphone 126, a display 128, and an input interface 130, and all of the above devices are coupled to the controller 120. The UE 100 may further comprise a camera module 136 for capturing static and/or dynamic images.

The UE 100 may further comprise a battery 134, such as a vibrating battery set, for supplying power to various circuits required for operating the user terminal 100 and alternatively providing mechanical vibration as detectable output. In one embodiment, the UE 100 may further comprise a user identification module (UIM) 138. The UIM 138 is usually a memory device with a processor built in. The UIM 138 may for example comprise a subscriber identification module (SIM), a universal integrated circuit card (UICC), a universal user identification module (USIM), or a removable user identification module (R-UIM), etc. The UIM 138 may comprise a card connection detecting apparatus according to embodiments of the subject matter described herein.

The UE 100 further comprises a memory. For example, the UE 100 may comprise a volatile memory 140, for example, comprising a volatile random access memory (RAM) in a cache area for temporarily storing data. The UE 100 may further comprise other non-volatile memory 142 which may be embedded and/or movable. The non-volatile memory 142 may additionally or alternatively include for example, EEPROM and flash memory, etc. The memory 140 may store any item in the plurality of information segments and data used by the UE 100 so as to implement the functions of the UE 100. For example, the memory may contain machine-executable instructions which, when executed, cause the controller 120 to implement the method described below.

It should be understood that the structural block diagram in FIG. 1 is shown only for illustration purpose, without suggesting any limitations on the scope of the subject matter described herein. In some cases, some devices may be added or reduced as required.

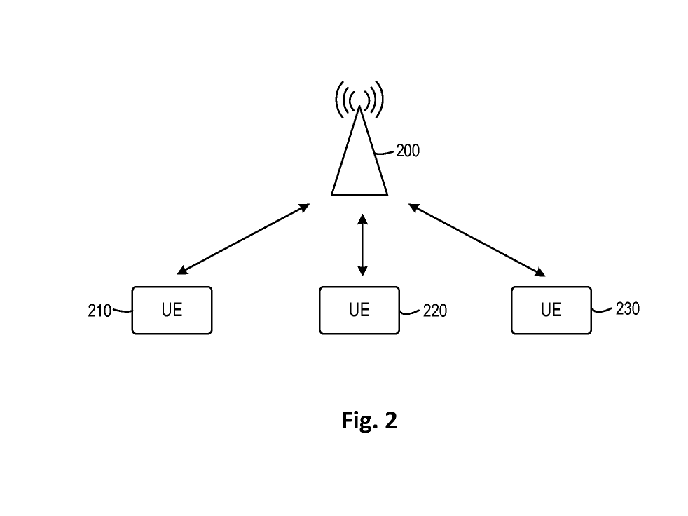

FIG. 2 shows an environment of a cellular system in which embodiments of the subject matter described herein may be implemented. As shown, one or more UEs may communicate with a BS 200. In this example, there are three UEs 210, 220 and 230. This is only for the purpose of illustration without suggesting limitations on the number of UEs. There may be any suitable number of UEs in communication with the BS 200. In one embodiment, one or more of the UEs 210, 220 and 230 may be implemented by the UE 100 as shown in FIG. 1, for example. In one embodiment, one or more of the UEs 210, 220 and 230 may be MTC devices.

The communications between the UEs 210, 220 and 230 and the BS 200 may be performed according to any appropriate communication protocols including, but not limited to, the first generation (1G), the second generation (2G), 2.5G, 2.75G, the third generation (3G), the fourth generation (4G) communication protocols, and/or any other protocols either currently known or to be developed in the future.

As introduced above, for a UE such as a MTC device with low transmission power, the coverage can be enhanced by repetition of the data transmission. In this scenario, the conventional request-based uplink transmission mechanism is inefficient. If the UE always requests uplink resource for the data transmission each time, significant latency will be introduced. Contrary to the request based solutions, embodiments of the subject matter described herein work on the basis of contention based uplink transmission.

Contention based transmission allows a plurality of UEs to directly transmit uplink data. However, it would be appreciated that in such contention based transmission, collisions may happen if more than two UEs use the shared resource to perform uplink transmission simultaneously. Conventional BSs are incapable of detecting and handling such collisions in contention based uplink transmission in effective and efficient way.

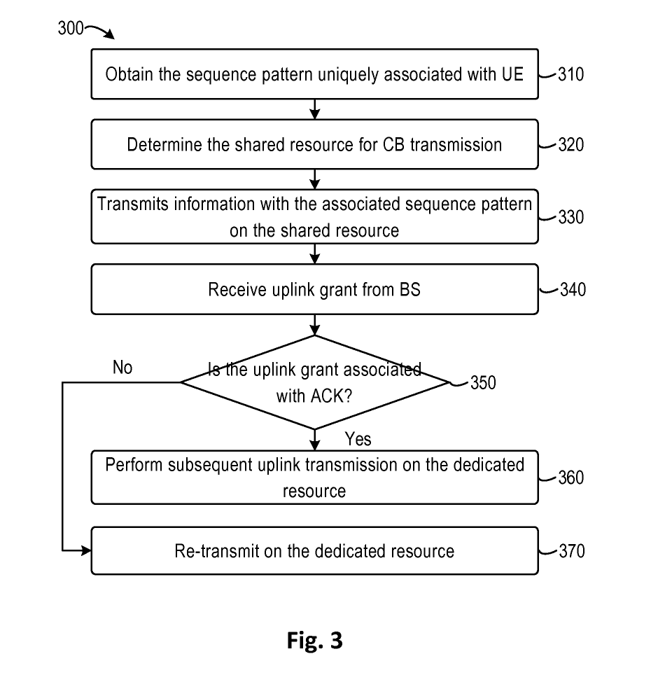

FIG. 3 shows a flowchart of a method 300 of contention based uplink transmission at the UE side in accordance with one embodiment of the subject matter described herein. It would be appreciated that the method 300 may be implemented by the UE working in the contention based transmission mode. For example, the method 300 may be implemented by the UE 210, 220 and/or 230 as shown in FIG. 2.

The method 300 is entered at step 310, where a UE obtains a pattern of sequences that is associated with that UE. A sequence is generated by a certain mathematical operation(s). Any suitable sequences, no matter already known or developed in the future, may be used in connection with embodiments described herein. In one embodiment, the sequences may be implemented as constant amplitude zero auto-correlation (CAZAC) sequences.

Examples of the CAZAC sequences include Zadoff-Chu sequence. A Zadoff-Chu sequence is a complex-valued mathematical sequence which, when applied to radio signals, gives rise to an electromagnetic signal of constant amplitude, whereby cyclically shifted versions of the sequence imposed on a signal result in zero correlation with one another at the receiver. A generated Zadoff-Chu sequence that has not been shifted is known as a “root sequence.” Different root sequences of Zadoff-Chu sequence or one root sequence with different cyclically shifted versions may be used. As known, different Zadoff-Chu sequences have low or zero cross-correlation to each other. That is, the cross-correlation among the sequences is below a predefined threshold. Specifically, when the cross-correlation is zero, the sequences are orthogonal to each other. This property exhibited by the Zadoff-Chu sequences would be beneficial to the recognition of different UEs in contention based transmission, which will be discussed below.

It is to be understood that the use of Zadoff-Chu sequences is only illustrative, without suggesting any limitations on the scope of the subject matter described herein. Alternatively, or in addition, Zadoff-Chu sequences with cyclic extension, ZC sequences with truncation, and the like can be used as well.

Given the collection of sequence, the BS may generate a plurality of sequence patterns. Each sequence pattern is defined by the permutation of the sequences. More specifically, each sequence pattern is defined by the plurality of sequences and their order. By way of example, assume that there are four sequences denoted as sequence A, B, C and D. Then the patterns may be defined by the permutation of these sequences. For example, a sequence pattern may be defined as {A, B, C, D}, another pattern may be defined as {A, B, D, C}, and so on. That is, each sequence pattern is associated with a unique order of the sequences. It is to be understood that a sequence may appear in a pattern more than once. For example, a pattern may be {A, A, B, C} or even {A, A, A, A}.

Moreover, the sequence patterns are not necessarily defined using all the sequences available at the BS. Instead, it is possible to define a sequence pattern only using some of the sequence. In the above example, pattern may be defined, for example, as {A, D, B}. The number of sequences used to generate the sequence patterns may be determined, for example, depending on the configuration of the shared resource for the contention based transmission. Examples in this regard will be discussed below. Moreover, in one embodiment, different patterns may contain different numbers of sequences.

In accordance with embodiments of the subject matter describe herein, each pattern is uniquely assigned to a UE, such that different UEs have different sequence patterns. The BS may inform individual UEs of their respective sequence patterns. For each UE, the BS may send the sequence pattern to the UE. Alternatively, it is possible to just send an indication or index of the sequence pattern. In one embodiment, the BS may send the sequence patterns or the indications thereof to the UEs in an initialization stage of the contention based transmission. Accordingly, at step 310, each UE may receive its associated sequence pattern from the BS.

Alternatively, in one embodiment, it is possible to define the associations between the UEs and the sequence patterns in advance, for example, by the service provider. Such predefined association may be stored in the UE. In this embodiment, a step 310, the UE may retrieve its associated sequence pattern from its local storage.

At step 320, the UE determines the shared resource for the contention based transmission. To this end, in one embodiment, the UE may receive configuration information about the shared resource from the BS. In one embodiment, the configuration information may specify a repetition time period or duration, for example, on physical uplink shared channel (PUSCH). Such repetition time period will be shared by multiple UEs for contention based uplink transmission.

For example, in one embodiment, the repetition time period may contain one or more contention based units (CB units). Each CB unit may include a plurality of consecutive subframes. The configuration information received at step 320 may specify the number of CB units contained in the repetition time period and the length of each CB unit, for example.

At step 320, the UE may determine any additional and/or alternative parameters related to the contention based transmission. For example, the UE may receive from the BS the configuration information about other parameters related to the contention based transmission including, but not limited to, the modulation and coding scheme (MCS), the amount of data to be carried, and the like.

It should be noted that although step 310 is performed prior to step 320 in FIG. 3, it is just for the purpose of illustration without suggesting any limitation to the subject matter described herein. The sequence pattern and the shared resource may be determined in any suitable order or in parallel.

The method 300 then proceeds to step 330, where the UE transmits information with the associated sequence pattern obtained at step 310 on the shared resource determined at step 320. In one embodiment, the UE may initiate uplink transmission, for example, in the repetition time period on PUSCH, as discussed above. Specifically, in accordance with embodiments of the subject matter described herein, the UE does not need to send a scheduling request in advance.

As described above, in one embodiment, the repetition time period may be divided into one or more CB units, each of which includes a plurality of subframes. In this embodiment, the sequence pattern may be transmitted on the basis of CB units. More specifically, each sequence in a pattern may be transmitted in a subframe of the CB unit. To this end, in one embodiment, the number of subframes included in a CB unit may be equal or less than the number of sequences that can be used to generate the sequence patterns. By way of example, when each pattern includes four sequences, a CB unit may include four consecutive subframes.

It is to be understood that the repetition time as described above is only for the purpose of illustration, without suggesting any limitations to the scope of the subject matter described herein. In another embodiment, the shared resource may be allocated on any other suitable uplink channel other than PUSCH. Moreover, the repetition time period is not necessarily organized as CB units. Depending on application and requirement, any other suitable resource configuration is possible.

According to the associated sequence pattern, at step 330, the UE may transmit the sequences in order. For the sake of discussion, it is assumed that the sequence patterns associated with the UEs 210, 220 and 230 in FIG. 2 are {A, B, C, D}, {A, B, D, C} and {A, C, B, D}, respectively. It is further assumed that the repetition time period includes multiple CB units, each of which includes four subframes. Then, the sequences may be transmitted in the plurality of subframes according to the order in each of the CB units. Specifically, within each CB unit in the repetition time period, UE 210 transmits sequence A, B, C and D in the first, second, third and fourth subframes, respectively. Likewise, the UE 220 sequentially transmits sequences A, B, D and C, and the UE 230 sequentially transmits sequences A, C, B and D.

In one embodiment, the sequence may be transmitted as the reference signal or pilot. As known, a subframe may contain a plurality of symbols. Some symbols are used to carry data while the others can be used to transmit reference signal or pilot. By way of example, a subframe may contain fourteen (14) symbols and may be of a length of 1 ms. Each subframe may contain two slots, each of a length of 0.5 ms, for example. These two slots may each contain a symbol for demodulation reference signal (DMRS).

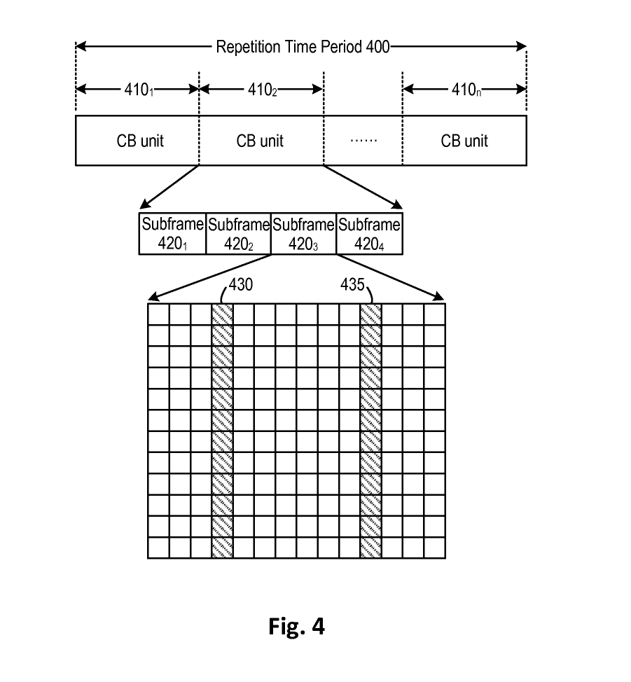

In this embodiment, the sequences may be transmitted as DMRS. FIG. 4 shows a schematic diagram of the contention based transmission in accordance with embodiments of the subject matter described herein. As shown, the repetition time period 400 includes one or more CB units 410₁, 410₂ . . . 410ₙ (collectively referred to as “CB units 410”). In the shown example, each CB unit 410 contains four subframes 420₁, 420₂, 420₃ and 420₄ (collectively referred to as “subframes 420”) with same or similar structures. In another embodiment, a CB unit 410 may include any suitable number of subframes 420. Each of the subframes 420 contains a plurality of symbols where the symbols 430 and 435 are DMRS symbols. In each subframe, the associated sequence may be transmitted using the symbols 430 and 435.

More specifically, in the example discussed above, within a CB unit 410, the UE 210 may transmit sequence A in the first subframe 420₂, sequence B in the second subframe 420₂, sequence C in the third subframe 420₃, and sequence D in the fourth subframe 420₄. In each of the subframes 420, the respective sequence is transmitted using the symbols 430 and 435. For the UE 220, sequences A, B, D and C are transmitted in the symbols 430 and 435 in the subframes 420₁, 420₂, 420₃ and 420₄, respectively, in each CB unit. For the UE 230, the sequences A, C, B and D are transmitted in the symbols 430 and 435 in the subframes 420₁, 420₂, 420₃ and 420₄, respectively, in each CB unit.

In the symbols other than the symbols 430 and 435, the UE may transmit other information. For example, the UE may transmit a buffer status report (BSR) to indicate the buffer status of the UE. Based on the BSR, the BS may allocate corresponding uplink resource to that UE by means of uplink grant. Depending on the MCS which is configured by the BS, in one embodiment, the UE may transmit additional information in the contention based transmission on PUSCH. Specifically, in one embodiment, the UE may transmit actual uplink data.

Still with reference to FIG. 3, in one embodiment, the UE may receive uplink grant from the BS at step 340. The uplink grant may allocate dedicated uplink resource to the UE. Then at step 350, the UE may determine whether the uplink grant is associated with the positive or negative acknowledgement. As discussed above, with the sequence pattern, the BS is able to recognize different UEs through the unique sequence patterns assigned for individual UEs. If the BS detects that there is only one UE performing contention based uplink transmission on the shared resource, then the BS may send the uplink grant associated with positive acknowledgement (ACK) to that UE.

On the contrary, if the BS detects that two or more UEs are simultaneously performing contention based transmission, there is collision among these UEs. In this event, the BS may recognize the colliding UEs based on the detected sequence patterns and schedule retransmission for these UEs. At this point, the BS may send the uplink grant associated with the negative acknowledgement (NACK) to each of the colliding UEs.

At step 350, if it is determined that the uplink grant is associated with ACK (branch “Yes”), the method 300 proceeds to step 360, where the UE perform subsequent uplink transmission on the dedicated resource. If it is determined that the uplink grant is associated with NACK (branch “No”), the method 300 proceeds to step 370, where the UE re-transmits the information using the dedicated resource.

Through the above discussion, it would be appreciated that by means of the sequence patterns, the BS is able to detect and handle the potential collision among multiple UEs that simultaneously perform contention based transmission on the share resource. Moreover, it is unnecessary for the UEs to transmit both the explicit scheduling request and the data in the contention based transmission simultaneously. Therefore, embodiments of the subject matter described herein comply with the single carrier property of Single-carrier Frequency-Division Multiple Access (SC-FDMA) uplink transmission. Furthermore, the peak-to-average-ratio (PAPR) for the uplink transmission will not be increased. In addition, the contention based transmission procedure is simplified.

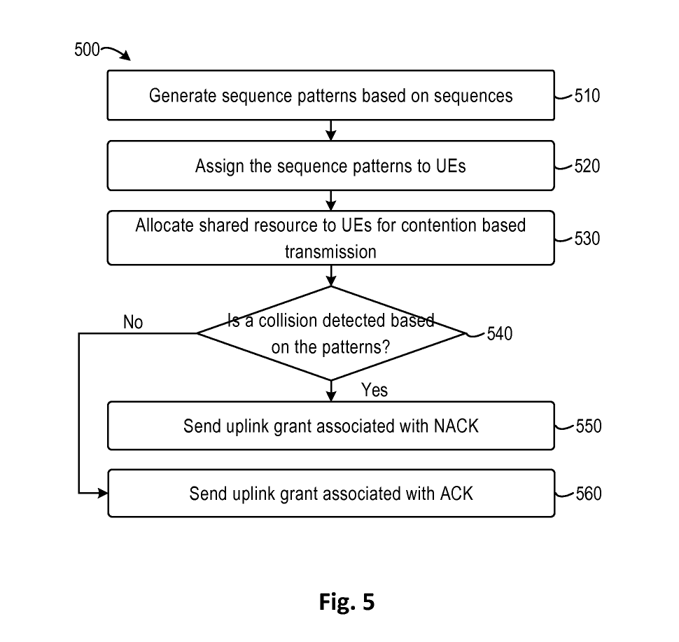

FIG. 5 illustrates a flowchart of a method 500 for controlling contention based uplink transmission at the BS side in accordance with one embodiment of the subject matter described herein. The method 500 may be implemented at least in part by the BS, for example, the BS 200 shown in FIG. 2.

The method 500 is entered at step 510, where the BS generates a plurality of sequence patterns based on a plurality of sequences. As discussed above, each sequence pattern may be defined by the plurality of sequences and an order of the plurality of sequences. For example, in one embodiment, the sequences like the Zadoff-Chu sequences with low or zero cross-correlation may be used to generate the sequence patterns.

Then, at step 520, the BS assigns the sequence patterns generated at step 510 to the UEs that are likely to perform contention based transmission, such that each UE is uniquely associated with one of the sequence patterns. In one embodiment, the BS may send the sequence patterns themselves. Alternatively, the BS may send indication or index of the sequence pattern to each UE. The UE may retrieve or otherwise determine the associated sequence pattern based on the indication or index. In this way, the UEs are associated with different sequence patterns.

It can be seen that in accordance with embodiments of the subject matter described herein, any given UE is not associated with a specific sequence. Instead, each UE is uniquely associated with a sequence pattern which contains multiple sequences in a certain order. This would be beneficial to the system capacity. By way of example, assume that there are N available sequences and the length of CB unit is T subframes, where N and T are both natural number and T<=N. The total available pattern is N*(N−1)*(N−2)* . . . *(N−T+1). In one embodiment where T=N, the total number of available sequence patterns is N!=N*(N−1)* . . . *1. By way of example, in case that there are four available sequences and a CB unit contains four subframes, the total number of available patterns is 4!=24. This means that up to 24 UEs can perform contention based uplink transmission simultaneously on the shared resource.

At step 530, the BS allocates shared resource for contention based transmission to the UEs. The resource may include both frequency and time domain position. For example, in one embodiment, the BS may send to the UEs the configuration information about the repetition time period in which the UEs are allowed to perform uplink transmission, for example, on PUSCH. At step 530, the BS may configure any other parameters related to the contention based transmission and send these parameters to the UEs. In one embodiment, for example, the BS may configure the MCS, the amount of data to be carried, and/or any other relevant parameters.

The method 500 proceeds to step 540, where the BS detects whether a collision occurs in the contention based transmission on the shared resource based on the plurality of sequence patterns. Specifically, the BS receives the transmission on the allocated shared resource, for example, in the repetition time period. The BS may detect the sequence pattern(s) in the received transmission. By way of example, in one embodiment where the sequence pattern(s) is transmitted on the basis of CB units, the BS may detect the sequences carried in the subframes within a complete CB unit. Based on the detected sequences and their order, the BS may determine the sequence pattern(s).

As discussed above, the sequences may have low or zero cross-correlation with each other and different UEs are associated with different sequence patterns. As a result, even if multiple UEs can perform contention based transmission simultaneously, the BS is capable of recognizing and distinguishing the colliding UEs by means of their associated sequence patterns. More specifically, if the BS detects two or more patterns, it means that two or more UEs are transmitting on the shared resource. That is, the collision occurs among these UEs (branch “Yes” at step 540). At this point, the method 500 proceed to step 550, where the BS sends uplink grant associated with NACK to the colliding UEs, such that those UEs can re-transmit the data using their respective dedicated resource.

On the other hand, if there is only one UE that is transmitting and thus no collision occurs (branch “No” at step 540), the method 500 proceed to 560, where the BS sends the uplink grant associated with ACK to the transmitting UE in order to allocate dedicated resource to the UE for subsequent uplink transmission.

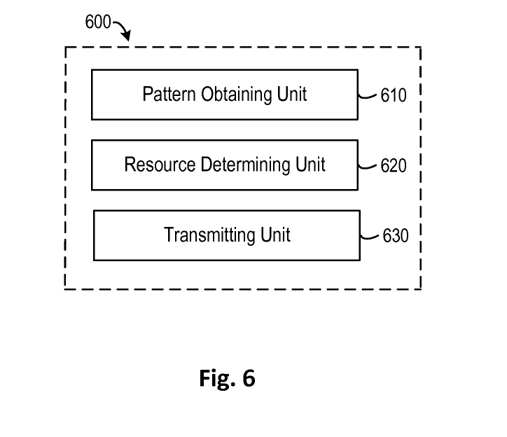

FIG. 6 shows a block diagram of an apparatus 600 for contention based uplink transmission at the UE side in accordance with one embodiment of the subject matter described herein. As shown, the apparatus 600 comprises: a pattern obtaining unit 610 configured to obtain a sequence pattern that is uniquely associated with the UE, the pattern defined by a plurality of sequences and an order of the plurality of sequences; a resource determining unit 620 configured to determine shared resource for contention based transmission; and a transmitting unit 630 configured to transmit information with the associated sequence pattern on the shared resource without sending a scheduling request.

In one embodiment, the plurality of sequences may include different sequences with low or zero cross-correlation. In one embodiment, such sequences may be obtained based on Zadoff-Chu sequences.

In one embodiment, the resource determining unit 620 is configured to receive, from a base station, configuration information of a repetition time period for the contention based transmission on physical uplink shared channel (PUSCH). In one embodiment, the repetition time period includes contention based (CB) unit, each of the CB units including a plurality of subframes. In this embodiment, the transmitting unit 630 is configured to transmit the plurality of sequences in the plurality of subframes according to the order in each of the CB units. In one embodiment, the plurality of sequences may be transmitted as DMRS in the plurality of subframes according to the order. In one embodiment, the transmitting unit 630 may be configured to at least transmit BSR for the UE.

In one embodiment, the apparatus 600 may further comprise: grant receiving unit configured to receive, from a base station, uplink grant that allocates dedicated resource to the UE; and re-transmitting unit configured to, the uplink grant being associated with NACK, re-transmit the information using the dedicated resource.

In one embodiment, the UE may include a machine type communication (MTC) device.

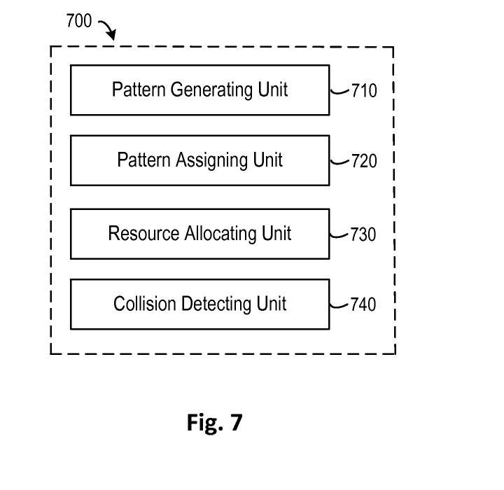

FIG. 7 shows a block diagram of an apparatus 700 for controlling contention based uplink transmission at the BS side in accordance with embodiments of the subject matter described herein. As shown, the apparatus 700 comprises a pattern generating unit 710 configured to generate a plurality of sequence patterns based on a plurality of sequences, each of the plurality of sequence patterns defined by the plurality of sequences and an order of the plurality of sequences; a pattern assigning unit 720 configured to assign the plurality of the sequence patterns to a plurality of user equipment (UEs), such that each of the plurality of UEs is uniquely associated with one of the plurality of the sequence patterns; a resource allocating unit 730 configured to allocate shared resource to the plurality of UEs for contention based transmission; and a collision detecting unit 740 configured to detect a collision in the contention based transmission based on the plurality of sequence patterns.

In one embodiment, the plurality of sequences may include sequences with cross-correlation below a predefined threshold. In one embodiment, such sequences may be obtained based on Zadoff-Chu sequences.

In one embodiment, the resource allocating unit 730 is configured to send, to the plurality of UEs, configuration information of a repetition time period for the contention based transmission on physical uplink shared channel (PDSCH). In one embodiment, the repetition time period includes contention based (CB) units, each of the CB units including a plurality of subframe. In this embodiment, the collision detecting unit 740 may be configured to determine number of sequence patterns in the contention based transmission by detecting the order of the plurality of sequences in at least one of the CB units. In one embodiment, the order of the plurality of sequences in at least one of the CB units is determined by detecting DMRS in the plurality of subframes included in the at least one of the CB units, where the plurality of sequences are transmitted as the DMRS. For example, in one embodiment, each of the plurality of subframes may carry one of the sequences as the DMRS.

In one embodiment, the apparatus 700 may further comprise: a grant sending unit configured to, responsive to detecting two or more sequence patterns of the plurality of sequence patterns in the contention based transmission, send uplink grant associated with negative acknowledgement (NACK) to two or more UEs of the plurality of UEs associated with the detected two or more sequence patterns; and a re-transmission receiving unit configured to receive re-transmission from the two or more UEs on respective dedicated resource allocated by the uplink grant.

The units included in the apparatuses 600 and/or 700 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses 600 and/or 700 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining, by user equipment (UE), a sequence pattern that is uniquely associated with the UE, the sequence pattern defined by a plurality of sequences and an order of the plurality of sequences;
determining, by the UE, shared resource for contention based transmission; and
transmitting, by the UE, information with the associated sequence pattern on the shared resource without sending a scheduling request.

2. The method according to claim 1, wherein the plurality of sequences include sequences with cross-correlation below a predefined threshold.

3. The method according to claim 2, wherein the sequences are obtained based on Zadoff-Chu sequences.

4. The method according to claim 1, determining the shared resource comprises:
receiving, from a base station, configuration information of a repetition time period for the contention based transmission on physical uplink shared channel (PUSCH).

5. The method according to claim 4, wherein the repetition time period includes contention based (CB) unit, each of the CB units including a plurality of subframes, and wherein transmitting the information with the associated sequence pattern comprises:
transmitting the plurality of sequences in the plurality of subframes according to the order in each of the CB units.

6. The method according to claim 5, wherein the plurality of sequences are transmitted as demodulation reference signal (DMRS) in the plurality of subframes according to the order.

7. The method according to claim 1, wherein the information at least includes a buffer status report (BSR) for the UE.

8. The method according to claim 1, further comprising:
receiving, from a base station, uplink grant that allocates dedicated resource to the UE; and
responsive to the uplink grant being associated with negative acknowledgement (NACK), re-transmitting the information using the dedicated resource.

9. The method according to claim 1, wherein the UE includes a machine type communication (MTC) device.

10. A method comprising:
generating, by a base station (BS), a plurality of sequence patterns based on a plurality of sequences, each of the plurality of sequence patterns defined by the plurality of sequences and an order of the plurality of sequences;
assigning, by the BS, the plurality of the sequence patterns to a plurality of user equipment (UEs), such that each of the plurality of UEs is uniquely associated with one of the plurality of the sequence patterns;
allocating, by the BS, shared resource to the plurality of UEs for contention based transmission; and
detecting, by the BS, a collision in the contention based transmission based on the plurality of sequence patterns.

11. The method according to claim 10, wherein the plurality of sequences include sequences with cross-correlation below a predefined threshold.

12. The method according to claim 11, wherein the sequences are obtained based on Zadoff-Chu sequences.

13. The method according to claim 10, wherein allocating the shared resource comprises:
sending, to the plurality of UEs, configuration information of a repetition time period for the contention based transmission on physical uplink shared channel (PUSCH).

14. The method according to claim 13, wherein the repetition time period includes contention based (CB) units, each of the CB units including a plurality of subframes, and wherein detecting the collision comprises:
determining number of sequence patterns in the contention based transmission by detecting the order of the plurality of sequences in at least one of the CB units.

15. The method according to claim 14, wherein detecting the order of the plurality of sequences in at least one of the CB units comprises:
detecting demodulation reference signal (DMRS) in the plurality of subframes included in the at least one of the CB units, the plurality of sequences being transmitted as the DMRS.

16. The method according to claim 10, further comprising:
responsive to detecting two or more sequence patterns of the plurality of sequence patterns in the contention based transmission, sending uplink grant associated with negative acknowledgement (NACK) to two or more UEs of the plurality of UEs associated with the detected two or more sequence patterns; and
receiving re-transmission from the two or more UEs on respective dedicated resource allocated by the uplink grant.

17. User equipment (UE) comprising:
a receiver configured to
receive an indication of a sequence pattern that is uniquely associated with the UE, the pattern defined by a plurality of sequences and an order of the plurality of sequences, cross-correlation among the plurality of sequences being below a predefined threshold, and
receive configuration information of shared resource for contention based transmission on physical uplink shared channel (PUSCH), the configure information at least indicating a repetition time period including contention based (CB) units, each of the CB units including a plurality of subframes; and
a transmitter configured to transmit information with the associated sequence pattern on the shared resource, the plurality of sequences being transmitted in the plurality of subframes according to the order in each of the CB units.

18. The UE according to claim 17, wherein the transmitter is configured to transmit the plurality of sequences as demodulation reference signal (DMRS) in the plurality of subframes according to the order in each of the CB units.

19. The UE according to claim 17, wherein the transmitter is configured to transmit a buffer status report (BSR) for the UE with the associated sequence pattern.

20. The UE according to claim 17, wherein the receiver is further configured to receive, from a base station, uplink grant that allocates dedicated resource to the UE,
and wherein the transmitter is configured to, responsive to the uplink grant being associated with negative acknowledgement (NACK), re-transmit the information using the dedicated resource.
